(19) United States
(12) Patent Application Publication
(10) Pub. No.: US 2026/0032718 A1
(43) Pub. Date: Jan. 29, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/996,937

(22) PCT Filed: Aug. 2, 2022
(86) PCT No.: PCT/CN2022/109758

§ 371 Date: Jan. 17, 2025

(51) Int. Cl. H04W 74/0808; H04W 24/10; H04W 84/12

(52) U.S. Cl. CPC H04W 74/0808; H04W 24/10; H04W 84/12

(57) ABSTRACT

A system and method for sensing by proxy (SBP) in wireless local area networks (WLAN) has facilitated efficient sensing measurement and exchange of data between SBP responders and initiators. The method includes determining a target radio frame that encapsulates sensing measurement results of target sensing responders, including their measurement types and additional metadata such as sensing order, identification information, and the number of measurements for different types. The system provides dynamic configuration capabilities through identification bits, enabling differentiation among sensing types such as null data packet announcement (NDPA) sounding, trigger frame (TF) sounding, and responder-to-responder (R2R) sensing. These devices enable SBP initiators to receive and process sensing results for enhanced WLAN operations, offering significant improvements in proxy sensing frameworks.

### CROSS-REFERENCE TO RELATED APPLICATION

The present application is a U.S. National Stage of International Application No. PCT/CN2022/109758, filed on Aug. 2, 2022, the contents of all of which are incorporated herein by reference in their entirety for all purposes.

### BACKGROUND OF THE INVENTION

With the rapid development of mobile communication technology, wireless fidelity (Wi-Fi) technology has made tremendous progress in terms of transmission rate as well as throughput. Currently, research on the Wi-Fi technology includes 320 MHz bandwidth transmission, aggregation and cooperation of a plurality of frequency bands, and so on. The application scenarios of the Wi-Fi technology include video transmission, augmented reality (AR), and virtual reality (VR), and so on.

The aggregation and cooperation of a plurality of frequency bands refers to simultaneous communication between devices in 2.4 GHz, 5.8 GHz, 6 GHz and other frequency bands. In the scenario of simultaneous communication between devices in a plurality of frequency bands, a new media access control (MAC) mechanism needs to be defined for management. Further, the aggregation and cooperation of a plurality of frequency bands is expected to be able to support low-latency transmission.

Currently, a maximum bandwidth to be supported in the aggregation and cooperation technology of a plurality of frequency bands is 320 MHz (160 MHz+160 MHz). In addition, 240 MHz (160 MHz+80 MHz) and other bandwidths supported by existing standards may also be supported possibly.

### SUMMARY OF THE INVENTION

The disclosure relates to the field of mobile communication, in particular to a communication method, an electronic device, and a storage medium.

In one aspect, a communication method is provided, using an example of disclosure. The communication method is performed by a sensing by proxy (SBP) responder, and includes:
determining a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result; and
transmitting the target radio frame to an SBP initiator.

In another aspect, a communication method is further provided according to an example of the disclosure. The communication method is performed by a sensing by proxy (SBP) initiator, and includes:
receiving a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result.

In yet another aspect, an electronic device is further provided according to an example of the disclosure. The electronic device is a sensing by proxy (SBP) responder. The electronic device includes:
a determination module configured to determine a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result; and
a transmission module configured to transmit the target radio frame to an SBP initiator.

In still another aspect, an electronic device is further provided according to an example of the disclosure. The electronic device is a sensing by proxy (SBP) initiator. The electronic device includes:
a reception module configured to receive a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result.

According to an example of the disclosure, an electronic device is further provided. The electronic device includes a memory, a processor, and a computer program stored on the memory and runnable on the processor. The processor performs the method according to one or more examples of the disclosure when executing the program.

According to an example of the disclosure, a non-transitory computer-readable storage medium storing a computer program is further provided. The computer program, when executed by a processor, implements the method according to one or more examples of the disclosure.

### BRIEF DESCRIPTION OF DRAWINGS

In order to describe the technical solutions in examples of the disclosure more clearly, the accompanying drawings needed to describe the examples of the disclosure are briefly described below. The accompanying drawings in the following description are merely some examples of the disclosure. Those of ordinary skill in the art can also derive other accompanying drawings from these accompanying drawings without creative efforts.

FIG. 1 is a first flowchart of a communication method according to an example of the disclosure.

FIG. 2 is a first schematic diagram of a first instance of an example of the disclosure.

FIG. 3 is a second schematic diagram of a first instance of an example of the disclosure.

FIG. 4 is a third schematic diagram of a first instance of an example of the disclosure.

FIG. 5 is a schematic diagram of a second instance of an example of the disclosure.

FIG. 6 is a second flowchart of a communication method according to an example of the disclosure.

FIG. 7 is a third flowchart of a communication method according to an example of the disclosure.

FIG. 8 is a fourth flowchart of a communication method according to an example of the disclosure.

FIG. 9 is a first schematic structural diagram of an electronic device according to an example of the disclosure.

FIG. 10 is a second schematic structural diagram of an electronic device according to an example of the disclosure.

FIG. 11 is a third schematic structural diagram of an electronic device according to an example of the disclosure.

### DETAILED DESCRIPTION OF THE INVENTION

In the embodiments of the present disclosure, the term “and/or” describes an association relation between associated objects and indicates that there may be three relations. For example, A and/or B may indicate three situations: A exists alone, A and B exist at the same time, and B exists alone. The character “/” generally indicates that successive associated objects are in an “or” relation.

In the examples of the disclosure, the term “a plurality of” refers to two or more, and other quantifiers are analogous to it.

Description will be made in detail to illustrative examples, and their instances are illustrated in the accompanying drawings. When the following description relates to the accompanying drawings, the same numbers in different accompanying drawings denote the same or similar elements, unless indicated otherwise. The embodiments described in the following illustrative examples do not denote all embodiments consistent with the disclosure. On the contrary, the embodiments are merely instances of apparatuses and methods consistent with some aspects of the disclosure, as recited in the appended claims.

The terms used in the disclosure are merely to describe the specific examples, instead of limiting the disclosure. The singular forms such as “a,” “an,” “the,” and “this” used in the disclosure and the appended claims are also intended to include the plural forms unless clearly stated otherwise in the context. It is also to be understood that the term “and/or” as used in the disclosure refers to and encompasses any or all possible combinations of one or more of associated items listed.

It is to be understood that although the terms “first,” “second,” “third,” etc. may be employed in the disclosure to describe various information, such information is not to be limited to these terms. These terms are merely used to distinguish the same type of information from each other. For example, first information can also be referred to as second information, and similarly, second information can also be referred to as first information, without departing from the scope of the disclosure. Depending on the context, the word “if”' as used in the disclosure can be interpreted as “at the time of,” “when,” or “in response to determining”.

The technical solutions in the examples of the present disclosure will be clearly and completely described below with reference to the accompanying drawings in the examples of the present disclosure. The described examples are merely some examples rather than all examples of the present disclosure. On the basis of the examples of the disclosure, all other examples derived by those of ordinary skill in the art without creative efforts fall within the scope of protection of the disclosure.

In the current Wi-Fi technology in research, a wireless local area network (WLAN) sensing technology may be supported, such as location discovery, proximity detection, and presence detection in dense environments (such as home environment and corporate environment). During the WLAN Sensing, the identities of a station (STA) and an access point (AP) may be interchangeable, for example, both can act as an initiator device (a sensing initiator or a sensing transmitter). In a case of acting as a sensing initiator or a sensing transmitter, the AP can communicate with a plurality of STAs simultaneously. However, the STA does not have the above function and can only communicate one-to-one with a single responder (a sensing responder), which causes a waste of spectrum resources and an increase in delay and may not be able to satisfy the delay requirements for communication scenarios with high delay requirements. In order to solve these problems, a method of performing the WLAN sensing measurement with the AP as a proxy for the STA, that is, sensing by proxy (SBP), has been proposed. During the SBP procedure, there are many types of sensing measurement such as a null data packet announcement (NDPA) sounding, trigger frame (TF) sounding and responder to responder (R2R) sensing. Accordingly, there is a need to provide a way of informing an SBP initiator of a sensing measurement type of a corresponding SBP procedure in order to refine the SBP mechanism.

According to an example of the disclosure, a communication method, an electronic device and a storage medium are provided, so as to solve the problem that a sensing by proxy (SBP) request becomes an invalid signaling message and results in waste of signaling resources.

The method and the device are based on the same application concept. Since the method and the device have the similar principles for solving problems, the device and the method may be implemented upon reference to each other, without repeated portions described in detail.

As shown in FIG. 1, a communication method is provided according to an example of the disclosure. The communication method may be performed by a sensing by proxy (SBP) responder, such as an access point (AP). The communication method may include steps 101 and 102.

In step 101, a target radio frame is determined. The target radio frame includes a measurement result of wireless local area network (WLAN) sensing. The measurement result of the WLAN sensing includes a sensing measurement result of a target sensing responder in a sensing measurement exchange and a sensing measurement type of the sensing measurement result.

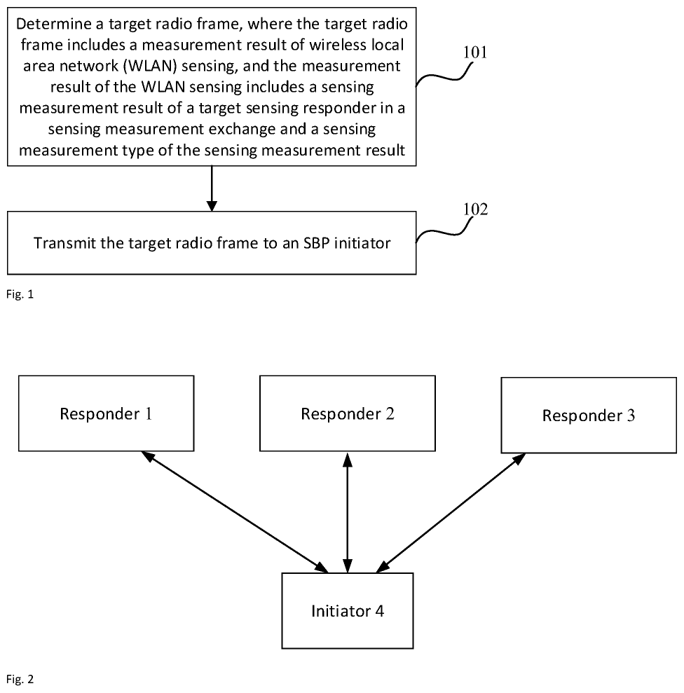

As a first instance, with reference to FIGS. 2-4, an architecture of the WLAN sensing and a procedure of the WLAN sensing applied by a method of sensing by proxy provided in the example of the disclosure are first introduced.

FIG. 2 is a schematic diagram of an architecture of the WLAN sensing (procedure). A sensing initiator 4 (or an initiator) initiates the WLAN sensing (for example, initiates a WLAN sensing session). A plurality of sensing responders (or sensing receivers) or responders, such as responder 1, responder 2 and responder 3 shown in FIG. 2, may respond to the WLAN sensing. In a case that the sensing initiator 4 initiates the WLAN sensing, a plurality of associated or unassociated sensing responders for the WLAN sensing may respond.

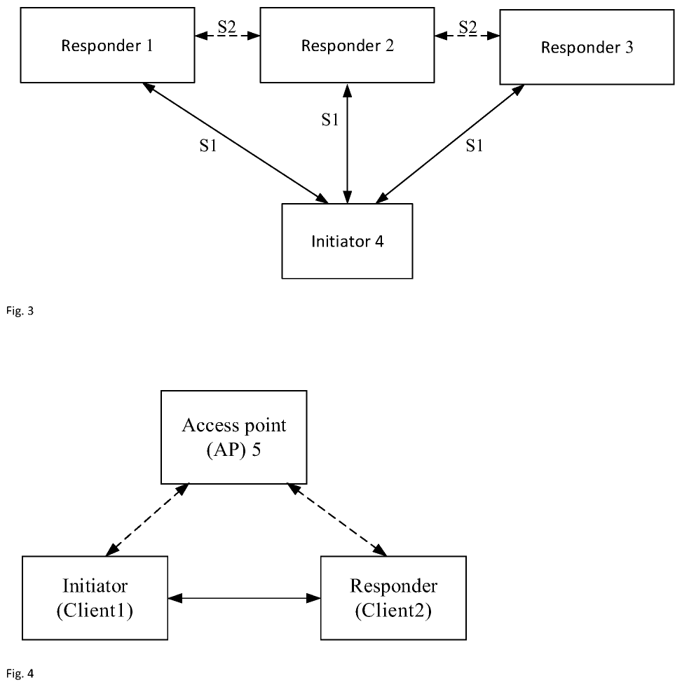

With reference to FIG. 3, the sensing initiator 4 communicates with the sensing responders 1, 2 and 3 through communication connection, for example, communication connection S1. The sensing responders 1, 2 and 3 communicate with each other through communication connection S2.

Each sensing initiator 4 may be a client. Each sensing responder (in this instance, sensing responder 1 to sensing responder 3) may be a station (STA) or an access point (AP). Furthermore, the STA and the AP may assume a plurality of roles in the procedure of the WLAN sensing. For example, the STA may also act as a sensing initiator in the procedure of the WLAN sensing, where the sensing initiator may be a sensing transmitter, a sensing receiver, both or neither. In the procedure of the WLAN sensing, the sensing responder may also be a sensing transmitter, a sensing receiver, or both.

As another architecture, as shown in FIG. 4, both the sensing initiator and the sensing responder may be clients, and may communicate with each other by being connected to a same access point (AP) 5. In FIG. 4, client 1 is the sensing initiator, and Client 2 is the sensing responder.

Generally, when acting as a sensing initiator or a sensing transmitter, the STA does not have a function of communicating with a plurality of receivers simultaneously, such that a proxy device (for example, an AP) is needed to serve as a proxy for the STA to perform trigger based (TB) sensing measurement, so as to improve efficiency of sensing measurement.

In the procedure of the SBP, the SBP responder determines the target radio frame. The target radio frame is configured to forward the sensing measurement result to the SBP initiator. The target radio frame includes the sensing measurement result of the target sensing responder in the sensing measurement exchange and the sensing measurement type of the sensing measurement result. The target radio frame includes one or more sensing measurement results of the target sensing responder in the sensing measurement exchange and the sensing measurement type of each sensing measurement result. The sensing measurement type includes at least one of null data packet announcement (NDPA) sounding, trigger frame (TF) sounding and responder to responder (R2R) sensing. In this way, in a case that the sensing responder includes at least two sensing measurement types in one sensing measurement exchange, the SBP initiator may calculate, according to different sensing measurement types, a more accurate sensing measurement result in combination with the sensing measurement results of the sensing responder.

For example, the sensing measurement results are forwarded to the SBP initiator by the SBP responder. For example, the sensing measurement results include a device identification of the sensing responder and a corresponding sensing measurement result of the sensing responder. The device identification may be for example a user identifier (UID) or an association identifier (AID), where the UID is allocated to an STA not establishing an initial association with the AP and has a length consistent with the AID. In this way, the SBP initiator may calculate a more accurate sensing measurement result by using the device identifier in combination with previous sensing measurement result of the sensing responder. However, during SBP sensing measurement, there are many sensing measurement types such as NDPA sounding, TF sounding and R2R sensing. In a case that one same STA participates in at least two types of sensing measurement, such as NDPA sounding and TF sounding, in one measurement exchange, the SBP initiator might combine, when combining sensing measurement results corresponding to the same device identifier, different types of sensing measurement results without distinguishing the sensing measurement types, influencing the measurement results and leading to inaccurate measurement results.

In an example, the target radio frame may be an SBP report frame.

In step 102, the target radio frame is transmitted to an SBP initiator.

The target radio frame is transmitted to the SBP initiator by the SBP responder.

After receiving the target radio frame, the SBP initiator combines the sensing measurement results of the same sensing responder in one sensing measurement exchange according to the sensing measurement types included in the target radio frame, and calculates a final sensing measurement result according to the sensing measurement type of each sensing measurement result, so as to improve the accuracy of the measurement result.

Further, the SBP responder as a SBP proxy initiates the WLAN sensing measurement. The initiated WLAN sensing measurement is TB sensing measurement. The TB sensing measurement is divided into a procedure of NDPA sounding (downlink (DL)) and a procedure of trigger frame sounding (uplink (UL)).

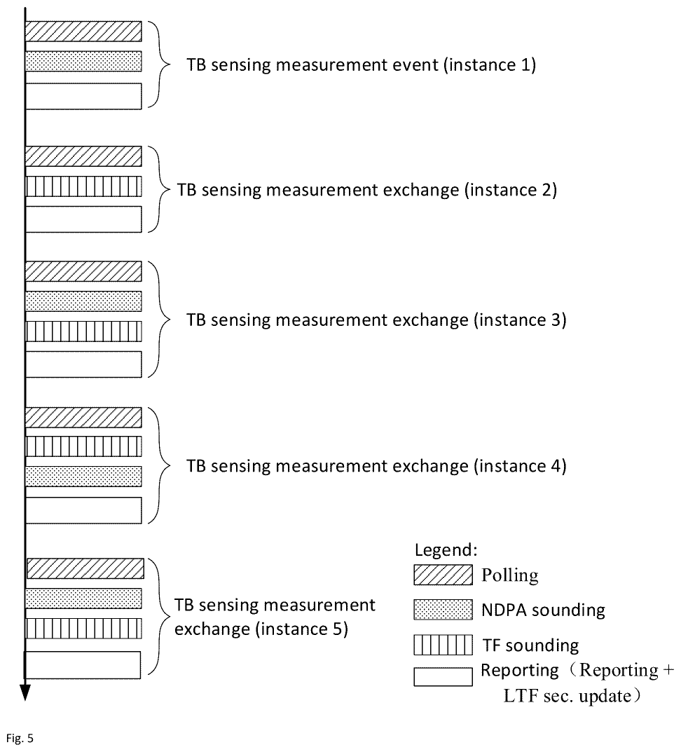

The WLAN sensing generally includes a way of triggered based (TB) sounding and a way of non-TB sensing. In the way of TB sounding, the AP is an initiator or a transmitter. In the way of non-TB sensing, the STA is an initiator or a transmitter. As a second instance, a procedure of the TB sensing measurement is shown in FIG. 5. FIG. 5 shows a plurality of sensing measurement exchanges for sensing measurement in one procedure of the TB sensing measurement. In instances 1-5, the procedure of the sensing measurement all includes polling, sounding, and reporting (reporting+LTF sec. update). In each instance, the sounding may include only NDPA sounding or TF sounding, or may include both of them. The SBP initiator may participate in the procedure of the NDPA sounding.

In the examples of the disclosure, the SBP responder includes the measurement result of the WLAN sensing in the target radio frame. The measurement result of the WLAN sensing includes the sensing measurement result of the target sensing responder in the sensing measurement exchange and the sensing measurement type of the sensing measurement result. Accordingly, after receiving the target radio frame, the SBP initiator may combine and calculate a final sensing measurement result according to the sensing measurement type of each sensing measurement result, improving accuracy of the measurement result. The examples of the disclosure provide a way of informing the SBP initiator of the sensing measurement type of the corresponding SBP procedure.

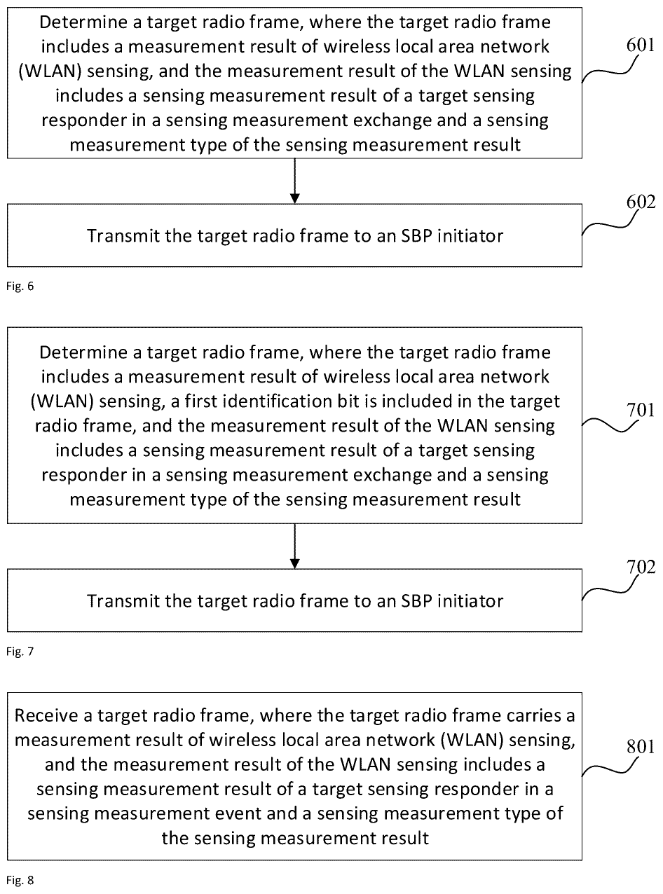

With reference to FIG. 6, a communication method is provided according to an example of the disclosure. The communication method may be performed by a sensing by proxy (SBP) responder, such as an access point (AP). The communication method may include steps 601 and 602.

In step 601, a target radio frame is determined. The target radio frame includes a measurement result of wireless local area network (WLAN) sensing. The measurement result of the WLAN sensing includes a sensing measurement result of a target sensing responder in a sensing measurement exchange and a sensing measurement type of the sensing measurement result.

In responding to the measurement result of the WLAN sensing including the sensing measurement results for at least two sensing measurement types, the sensing measurement results are encapsulated according to a preset sensing measurement order of each sensing measurement type. The preset sensing measurement order refers to a measurement order preset for each sensing measurement type. For example, downlink NDPA sounding and uplink TF sounding have a preset measurement order, that is, the NDPA sounding is before the TF sounding, and then the sensing measurement results of these two sensing measurement types are encapsulated in the order in an SBP report frame transmitted to the SBP initiator by the SBP responder. In this way, after receiving the target radio frame, the SBP initiator may determine the sensing measurement type of each sensing measurement result according to the encapsulation order of the sensing measurement results (the SBP initiator may inversely deduce the encapsulation order according to a decapsulation order) and the preset measurement order.

In step 602, the target radio frame is transmitted to an SBP initiator.

The target radio frame is transmitted to the SBP initiator by the SBP responder. After receiving the target radio frame, the SBP initiator combines the sensing measurement results of the same sensing responder in one sensing measurement exchange according to the sensing measurement types included in the target radio frame, and calculates a final sensing measurement result according to the sensing measurement type of each sensing measurement result, so as to improve the accuracy of the measurement result.

With reference to FIG. 7, a communication method is provided according to an example of the disclosure. The communication method may be performed by a sensing by proxy (SBP) responder, such as an access point (AP). The communication method may include steps 701 and 702.

In step 701, a target radio frame is determined. The target radio frame includes a measurement result of wireless local area network (WLAN) sensing. A first identification bit is also included in the target radio frame. The measurement result of the WLAN sensing includes a sensing measurement result of a target sensing responder in a sensing measurement exchange and a sensing measurement type of the sensing measurement result.

In a case that the first identification bit is a first parameter value, the sensing measurement type includes null data packet announcement (NDPA) sounding.

In a case that the first identification bit is a second parameter value, the sensing measurement type includes trigger frame (TF) sounding.

Alternatively, in a case that the first identification bit is a third parameter value, the sensing measurement type includes responder to responder (R2R) sensing.

In a case that there are only two sensing measurement types, the first identification bit occupies one bit. For example, in a case that the two sensing measurement types are NDPA sounding and TF sounding, “1” is identified as a sensing measurement result of the NDPA sounding, and “0” is identified as a sensing measurement result of the TF sounding. In a case that there are three sensing measurement types, the first identification bit occupies two bits. “00” is identified as a sensing measurement result of the NDPA sounding, “01” is identified as a sensing measurement result of the TF sounding, and “10” is identified as a sensing measurement result of the R2R sensing.

In step 702, the target radio frame is transmitted to an SBP initiator.

According to an example of the disclosure, a communication method is provided. The communication method may be performed by a sensing by proxy (SBP) responder, such as an access point (AP). The communication method may include:
determining a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result;
including a number information field in the target radio frame in responding to the measurement result of the WLAN sensing including sensing measurement results of at least two sensing measurement types, where the number information field includes information of the number of the sensing measurement results of each sensing measurement type; and
transmitting the target radio frame to an SBP initiator.

The number information field is included in the target radio frame. The number information field includes information of the number of the sensing measurement results of each sensing measurement type. In this way, the SBP initiator may determine the number of the received sensing measurement results and count the sensing measurement results of each sensing measurement type.

According to an example of the disclosure, a communication method is provided. The communication method may be performed by a sensing by proxy (SBP) responder, such as an access point (AP). The communication method may include:
determining a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result;
including, in the target radio frame, identification information of a sensing responder corresponding to each sensing measurement result; and
transmitting the target radio frame to an SBP initiator.

The identification information is such as a user identifier (UID) or an association identifier (AID). In this way, after receiving the target radio frame, the SBP initiator may count the sensing measurement results of the sensing responder by using the identification information, and calculate a more accurate sensing measurement result.

In the examples of the disclosure, the SBP responder includes the measurement result of wireless local area network (WLAN) sensing in the target radio frame. The measurement result of the WLAN sensing includes the sensing measurement result of the target sensing responder in the sensing measurement exchange and the sensing measurement type of the sensing measurement result. Accordingly, after receiving the target radio frame, the SBP initiator may combine and calculate a final sensing measurement result according to the sensing measurement type of each sensing measurement result, improving accuracy of the measurement result.

With reference to FIG. 8, a communication method is provided according to an example of the disclosure. The communication method may be performed by a sensing by proxy (SBP) initiator. A network device may be a station (STA). The communication method may include step 801.

In step 801, a target radio frame is received. The target radio frame includes a measurement result of wireless local area network (WLAN) sensing. The measurement result of the WLAN sensing includes a sensing measurement result of a target sensing responder in a sensing measurement exchange and a sensing measurement type of the sensing measurement result.

Reference may be made to the first instance for the architecture of the WLAN sensing and the procedure of the WLAN sensing applied to the communication method provided in the example of the disclosure, which is not repeated.

Generally, when acting as a sensing initiator or a sensing transmitter, the STA does not have a function of communicating with a plurality of receivers simultaneously, such that a proxy device (for example, AP) is needed to serve as a proxy for the STA to perform triggered based (TB) sounding, so as to improve efficiency of sensing measurement.

In the SBP procedure, the target radio frame is transmitted to the SBP initiator by the SBP responder. The target radio frame is configured to forward a sensing measurement result to the SBP initiator. The target radio frame includes a sensing measurement result of a target sensing responder in a sensing measurement exchange and a sensing measurement type of the sensing measurement result. The target radio frame includes one or more sensing measurement results of the target sensing responder in one sensing measurement exchange and a sensing measurement type of each sensing measurement result. The sensing measurement type includes at least one of NDPA sounding, TF sounding and R2R sensing. In this way, in a case that one sensing responder includes at least two sensing measurement types in one sensing measurement exchange, the SBP initiator may calculate a more accurate sensing measurement result in combination with the sensing measurement results of the sensing responder according to different sensing measurement types.

For example, the sensing measurement results are forwarded to the SBP initiator by the SBP responder. For example, the sensing measurement results include a device identification of the sensing responder and a corresponding sensing measurement result of the sensing responder. The device identification may be for example a user identifier (UID) or an association identifier (AID). In this way, the SBP initiator may calculate a more accurate sensing measurement result by using the device identifier in combination with previous sensing measurement result of the sensing responder. However, during SBP sensing measurement, there are many sensing measurement types such as NDPA sounding, TF sounding and R2R sensing. In a case that one same STA participates in at least two types of sensing measurement, such as NDPA sounding and TF sounding, in one measurement exchange, the SBP initiator might combine, when combining sensing measurement results corresponding to the same device identifier, different types of sensing measurement results without distinguishing the sensing measurement types, influencing the measurement results and leading to inaccurate measurement results.

In an example, the target radio frame may be an SBP report frame.

After receiving the target radio frame, the SBP initiator combines the sensing measurement results of the same sensing responder in one sensing measurement exchange according to the sensing measurement types included in the target radio frame, and calculates a final sensing measurement result according to the sensing measurement type of each sensing measurement result, so as to improve the accuracy of the measurement result.

With reference to FIG. 9, based on a same principle as the method provided in the examples of the disclosure, an electronic device is further provided according to an example of the disclosure. The electronic device 900 is a sensing by proxy (SBP) responder. The electronic device 900 includes a determination module 901 and a transmission module 902.

The determination module 901 is configured to determine a target radio frame. The target radio frame includes a measurement result of wireless local area network (WLAN) sensing. The measurement result of the WLAN sensing includes a sensing measurement result of a target sensing responder in a sensing measurement exchange and a sensing measurement type of the sensing measurement result.

The transmission module 902 is configured to transmit the target radio frame to an SBP initiator.

In an example, the determination module 901 is configured to encapsulate the sensing measurement results according to a preset sensing measurement order of each sensing measurement type in responding to the measurement result of the WLAN sensing including sensing measurement results of at least two sensing measurement types.

In an example, the determination module 901 is configured to include a first identification bit in the target radio frame.

In a case that the first identification bit is a first parameter value, the sensing measurement type includes null data packet announcement (NDPA) sounding.

In a case that the first identification bit is a second parameter value, the sensing measurement type includes trigger frame (TF) sounding.

In a case that the first identification bit is a third parameter value, the sensing measurement type includes responder to responder (R2R) sensing.

In an example, the determination module 901 is configured to include a number information field in the target radio frame in responding to the measurement result of the WLAN sensing including sensing measurement results of at least two sensing measurement types. The number information field includes information of the number of the sensing measurement results of each sensing measurement type.

In an example, the determination module 901 is configured to include, in the target radio frame, identification information of a sensing responder corresponding to each sensing measurement result.

In the examples of the disclosure, the determination module 901 includes the measurement result of the WLAN sensing in the target radio frame. The transmission module 902 transmits the target radio frame to the SBP initiator. The measurement result of the WLAN sensing includes the sensing measurement result of the target sensing responder in the sensing measurement exchange and the sensing measurement type of the sensing measurement result. Accordingly, after receiving the target radio frame, the SBP initiator may combine and calculate a final sensing measurement result according to the sensing measurement type of each sensing measurement result, improving accuracy of the measurement result.

According to an example of the disclosure, a communication device is further provided. The communication device (not shown) is applied to a sensing by proxy (SBP) responder and includes:
a radio frame determination module (not shown) configured to determine a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result; and
a radio frame transmission module (not shown) configured to transmit the target radio frame to an SBP initiator.

The communication device further includes other modules of the electronic device in the examples of the disclosure, which are not repeated.

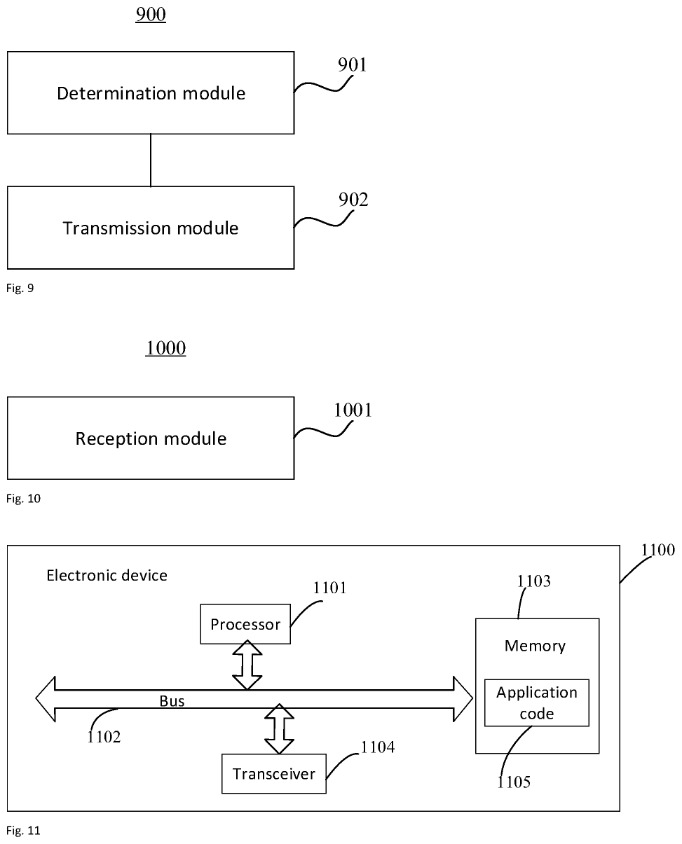

With reference to FIG. 10, based on a same principle as the method provided in the examples of the disclosure, an electronic device is further provided according to an example of the disclosure. The electronic device 1000 is a sensing by proxy (SBP) initiator. The electronic device 1000 includes a reception module 1001.

The reception module 1001 is configured to receive a target radio frame. The target radio frame includes a measurement result of wireless local area network (WLAN) sensing. The measurement result of the WLAN sensing includes a sensing measurement result of a target sensing responder in a sensing measurement exchange and a sensing measurement type of the sensing measurement result.

A communication device is further provided according to an example of the disclosure. The communication device (not shown) is applied to an SBP initiator and includes:
a radio frame reception module (not shown) configured to receive a target radio frame, where the target radio frame includes a measurement result of wireless local area network (WLAN) sensing, and the measurement result of the WLAN sensing includes a sensing measurement result of a target sensing responder in a sensing measurement exchange and a sensing measurement type of the sensing measurement result.

The communication device further includes other modules of the electronic device in the examples of the disclosure, which are not repeated.

According to an example of the disclosure, an electronic device is further provided as shown in FIG. 11. The electronic device 1100 shown in FIG. 11 may be a server, and includes a processor 1101 and a memory 1103. The processor 1101 is connected to the memory 1103, for example, via a bus 1102. The electronic device 1100 may further include a transceiver 1104. It is to be noted that in practical application, the transceiver 1104 is not limited to one. The structure of the electronic device 1100 does not constitute a limitation to the example of the disclosure.

The processor 1101 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination of them. The processor 1101 may implement or execute various illustrative logical blocks, modules, and circuits described in connection with contents disclosed in the disclosure. The processor 1101 may also be a combination realizing a computation function, for example, a combination including one or more microprocessors, a combination of a DSP and a microprocessor, etc.

The bus 1102 may include a path to transfer information between the above components. The bus 1102 may be a peripheral component interconnect (PCI) bus, an extended industry standard architecture (EISA) bus, etc. The bus 1102 may be classified into an address bus, a data bus, a control bus, and the like. For ease of presentation, the bus 1102 is shown with only one thick line in FIG. 11, but it does not indicate that there is only one bus or one type of buses.

The memory 1103 may be a read only memory (ROM) or other type of static storage devices capable of storing static information and instructions, a random access memory (RAM) or other type of dynamic storage devices capable of storing information and instructions, an electrically erasable programmable read only memory (EEPROM), a compact disc read only memory (CD-ROM) or other optical disk storages, optical disk storage (including a compact disc, a laser disc, an optical disc, a digital versatile disc, a Blue-ray disc, etc.), a magnetic disk storage medium or other magnetic storage devices, or any other media that may be configured to carry or store desired program codes in a form of instructions or data structures and that may be accessed by a computer, but is not limited in the disclosure.

The memory 1103 is configured to store an application code 1105 for executing the solutions of the disclosure, and execution is controlled by the processor 1101. The processor 1101 is configured to execute the application code 1105 stored in the memory 1103, so as to implement the contents shown in the method examples.

The electronic device 1100 includes, but is not limited to, mobile terminals such as a mobile phone, a notebook computer, a digital stream receiver, a personal digital assistant (PDA), a portable android device (PAD), a portable multimedia player (PMP), and an in-vehicle terminal (for example, an in-vehicle navigation terminal), and fixed terminals such as a digital television (TV) and a desktop computer. The electronic device 1100 illustrated in FIG. 11 is merely an instance and does not impose any limitation on the functions and scope of use of the examples of the disclosure.

The server provided in the disclosure may be an independent physical server, a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be a smart phone, a tablet computer, a notebook computer, a desktop computer, a smart slightly speaker, a smart watch, etc., but is not limited to this. The terminal and the server may be connected directly or indirectly through wired or wireless communication, which is not limited in the disclosure.

According to an example of the disclosure, a non-transitory computer-readable storage medium is provided. The non-transitory computer-readable storage medium stores a computer program. When running on a computer, the computer program causes the computer to execute the corresponding contents in the method examples.

It is to be understood that while all the steps in the flowcharts of the accompanying drawings are shown sequentially as indicated by arrows, the steps are not necessarily executed sequentially in an order indicated by the arrows. Unless explicitly stated in the disclosure, an execution order of these steps is not strictly limited, and these steps can be executed in other orders. Moreover, at least a part of the steps in the flowcharts of the accompanying drawings can include a plurality of sub-steps or stages. These sub-steps or stages are not necessarily executed at the same time, but can be executed at different times. These sub-steps or stages are not necessarily executed sequentially, but can be executed in turn or alternately with other steps or at least a part of sub-steps or stages of other steps.

It is to be noted that the non-transitory computer-readable medium in the disclosure may be a computer-readable signal medium or a non-transitory computer-readable storage medium, or any combination of a computer-readable signal medium and a non-transitory computer-readable storage medium. The non-transitory computer-readable storage medium may include, but is not limited to, an electronic, magnetic, optical, electromagnetic, infrared, or semiconductor system, apparatus, or device, or any combination of the foregoing. Instance of the non-transitory computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the disclosure, the non-transitory computer-readable storage medium may be any tangible medium that includes or stores a program for use by or in conjunction with an instruction execution system, apparatus, or device. In the disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can transmit, propagate, or transfer a program for use by or in conjunction with an instruction execution system, apparatus, or device. A program code included on a computer-readable medium may be transferred by means of any suitable medium, including, but is not limited to, wires, fiber optic cables, radio frequency (RF), etc., or any suitable combination of the foregoing.

The computer-readable medium may be included in the electronic device of the disclosure, and may also exist independently without being installed into the electronic device.

The computer-readable medium carries one or more programs. When executed by the electronic device, the one or more programs cause the electronic device to execute the method shown in the examples of the disclosure.

According to an aspect of the disclosure, a computer program product or a computer program is further provided. The computer program product or the computer program includes a computer instruction. The computer instruction is stored in a non-transitory computer-readable storage medium. A processor of a computer reads the computer instruction from the non-transitory computer-readable storage medium. The processor executes the computer instruction to cause the computer to execute the methods of the embodiments described in the disclosure.

A computer program code for performing operations of the disclosure may be written in one or more programming languages, or combinations of the programming languages. The programming languages include target-oriented programming languages, such as Java, Smalltalk, and C++, and further include conventional procedural programming languages, such as C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with the user computer through any kind of network, including a local area network (LAN) or a wide area network (WAN), or may be connected with an external computer (for example, connected through the Internet by using an Internet service provider).

In the examples of the disclosure, the SBP responder includes the measurement result of the WLAN sensing in the target radio frame. The measurement result of the WLAN sensing includes the sensing measurement result of the target sensing responder in the sensing measurement exchange and the sensing measurement type of the sensing measurement result. Accordingly, after receiving the target radio frame, the SBP initiator may combine and calculate a final sensing measurement result according to the sensing measurement type of each sensing measurement result, improving accuracy of the measurement result.

The flowcharts and block diagrams in the accompanying drawings illustrate the architecture, functionality, and operations possibly implemented by the systems, methods, and computer program products according to various examples of the disclosure. In this regard, each block in the flowcharts or block diagrams may represent a module, a program segment, or part of a code, and the module, the program segment, or the part of the code includes one or more executable instructions for implementing a specified logical function. It is also to be noted that in some alternative implementations, a function noted in a block may occur in a different order than an order noted in the figures. For example, two consecutive blocks may actually be executed substantially in parallel, or in a reverse order sometimes, depending on a function involved. It is also to be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The modules described in the example of the disclosure may be implemented in software or hardware. The name of a module does not constitute a qualification of the module itself, for example, a module A can also be described as “module A for executing operation B”.

The above description is merely illustrative of examples of the disclosure and principles of the technology employed. It is to be understood by those skilled in the art that the disclosed scope involved in the disclosure is not limited to the technical solutions in which the above-described technical features are specifically combined, but encompasses other technical solutions in which the above-described technical features or equivalent features are arbitrarily combined without departing from the concept of the disclosure, for example, technical solutions formed by interchanging the features described above with (non-limiting) technical features disclosed in the disclosure that have similar functions.

1. A measurement method for sensing by proxy, performed by a sensing by proxy (SBP) responder, comprising:
determining a target radio frame, wherein the target radio frame comprises a measurement result of wireless local area network (WLAN) sensing, and the measurement result of the WLAN sensing comprises a sensing measurement result of a target sensing responder in a sensing measurement exchange and a sensing measurement type of the sensing measurement result; and
transmitting the target radio frame to an SBP initiator.

2. The measurement method for sensing by proxy according to claim 1, wherein determining the target radio frame comprises:
encapsulating the sensing measurement results according to a preset sensing measurement order of each sensing measurement type, in responding to the measurement result of the WLAN sensing comprising sensing measurement results of at least two sensing measurement types.

3. The measurement method for sensing by proxy according to claim 1, wherein determining the target radio frame comprises:
comprising a first identification bit in the target radio frame, wherein
in a case that the first identification bit is a first parameter value, the sensing measurement type comprises null data packet announcement (NDPA) sounding;
in a case that the first identification bit is a second parameter value, the sensing measurement type comprises trigger frame (TF) sounding;
in a case that the first identification bit is a third parameter value, the sensing measurement type comprises responder to responder (R2R) sensing.

4. The measurement method for sensing by proxy according to claim 1, wherein determining the target radio frame comprises:
comprising a number information field in the target radio frame in responding to the measurement result of the WLAN sensing comprising sensing measurement results of at least two sensing measurement types, wherein the number information field comprises information of the number of the sensing measurement results of each sensing measurement type.

5. The measurement method for sensing by proxy according to claim 1, wherein determining the target radio frame comprises:
comprising, in the target radio frame, identification information of a sensing responder corresponding to each of a plurality of sensing measurement results, wherein the plurality of sensing measurement results includes the sensing measurement result.

6. A measurement method for sensing by proxy, performed by a sensing by proxy (SBP) initiator, comprising:
receiving a target radio frame, wherein the target radio frame comprises a measurement result of wireless local area network (WLAN) sensing, and the measurement result of the WLAN sensing comprises a sensing measurement result of a target sensing responder in a sensing measurement exchange and a sensing measurement type of the sensing measurement result.

7. (canceled)

8. (canceled)

9. An electronic device, comprising:
a memory that stores a computer program; and
one or more processors that are communicatively coupled to the memory.
wherein the computer program when collectively executed by the one or more processors cause the electronic device to:
determine a target radio frame, wherein the target radio frame comprises a measurement result of wireless local area network (WLAN) sensing, and the measurement result of the WLAN sensing comprises a sensing measurement result of a target sensing responder in a sensing measurement exchange and a sensing measurement type of the sensing measurement result; and
transmit the target radio frame to an SBP initiator.

10. A non-transitory computer-readable storage medium, storing a computer program, wherein the computer program when executed by a processor of a sensing by proxy (SBP) responder cause the SBP responder to perform the measurement method according to claim 1.

11. The electronic device according to claim 9, wherein the computer program when collectively executed by the one or more processors further cause the electronic device to:
encapsulate the sensing measurement result according to a preset sensing measurement order of each sensing measurement type, in responding to the measurement result of the WLAN sensing comprising sensing measurement results of at least two sensing measurement types.

12. The electronic device according to claim 9, wherein the computer program when collectively executed by the one or more processors cause the electronic device to:
comprise a first identification bit in the target radio frame, wherein
in a case that the first identification bit is a first parameter value, the sensing measurement type comprises null data packet announcement (NDPA) sounding;
in a case that the first identification bit is a second parameter value, the sensing measurement type comprises trigger frame (TF) sounding;
in a case that the first identification bit is a third parameter value, the sensing measurement type comprises responder to responder (R2R) sensing.

13. The electronic device according to claim 9, wherein the computer program when collectively executed by the one or more processors cause the electronic device to:
comprise a number information field in the target radio frame in responding to the measurement result of the WLAN sensing comprising sensing measurement results of at least two sensing measurement types, wherein the number information field comprises information of the number of the sensing measurement results of each sensing measurement type.

14. The electronic device according to claim 9, wherein the computer program when collectively executed by the one or more processors cause the electronic device to:
comprise, in the target radio frame, identification information of a sensing responder corresponding to each of a plurality of sensing measurement results, wherein the plurality of sensing measurement results includes the sensing measurement result.

15. An electronic device, comprising:
a memory that stores a computer program,
one or more processors that are communicatively coupled to the memory,
wherein the computer program when collectively executed by the one or more processors causes the electronic device to act as a sensing by proxy (SBP) initiator and perform the measurement method according to claim 6.

16. A non-transitory computer-readable storage medium, storing a computer program, wherein the computer program when executed by a processor of a sensing by proxy (SBP) initiator cause the SBP initiator to perform the method according to claim 6.
